(19) United States
(12) Patent Application Publication
(10) Pub. No.: US 2012/0315182 A1
(43) Pub. Date: Dec. 13, 2012

(54) Preparation of R5X4 materials by carbothermic processing

(75) Inventors: Karl A. Gschneider, JR., Ames, IA (US); Frederick A. Schmidt, Ames, IA (US); Alexandra O. Tsokol, Denver, CO (US); Vitalij K. Pecharsky, Ames, IA (US); Lawrence L. Jones, Des Moines, IA (US); Paul B. Wheelock, indianapolis, IN (US)

(73) Assignee: Iowa State University Research Foundation, Inc.

(21) Appl. No.: 13/506,434

(22) Filed: Apr. 18, 2012

Related U.S. Application Data
(63) Continuation of application No. PCT/US2010/002843, filed on Oct. 27, 2010.
(60) Provisional application No. 61/280,212, filed on Oct. 30, 2009.

(51) Int. Cl. C22B 59/00; H01F 1/01

(52) U.S. Cl. 420/416; 75/610

(57) ABSTRACT

A method for preparing R₅X₄ alloy materials where R is a rare earth element selected from one or more of La, Ce, Sm, Eu, Gd, Tb, Dy, Ho, Er, Tm, Lu, Sc, and Y and X represents a non-rare earth alloying element such as silicon, germanium, tin, lead, gallium, indium and mixtures thereof. The method involves carbothermically reducing amounts of a rare earth element-containing oxide, an alloying element-containing oxide and/or alloying element in elemental or alloy form, and carbon at elevated temperature to form an R₅X₄ alloy material, which is melted, solidified, and optionally heat treated. Such a method provides an economical and efficient technique of configuring magnetic refrigerant, magnetostrictive and magnetoresistive alloys and products.

This application claims benefits and priority of U.S. provisional application Ser. No. 61/280,212 filed Oct. 30, 2009, the disclosure of which is incorporated herein by reference.

### CONTRACTUAL ORIGIN OF THE INVENTION

This invention was made with government support under Contract DE-AC02-07CH11358 awarded by the Department of Energy. The Government has certain rights in the invention.

### FIELD OF THE INVENTION

The present invention relates to the field of carbothermic processing to produce alloy materials represented by R₅X₄ that can be melted, solidified and optionally heat treated to provide a magnetic refrigerant alloy with large magnetocaloric values, a magnetostrictive alloy, and a magnetoresistive alloy.

### BACKGROUND OF THE INVENTION

Carbothermic reactions are thermochemical reactions, which use carbon as the reducing agent at a high temperature. The most prominent example is used in iron ore smelting. Over the last 100 years various attempts have been made to prepare pure refractory and rare earth metals and alloys by carbothermic processing. Some success was achieved, but high purity materials were not obtained and consistently contained large amounts of carbon (usually as metallic carbides) and other interstitials.

During World War II high vacuum equipment and techniques were developed which opened the way for a great expansion of vacuum metallurgy. In 1948, W. J. Kroll of the U.S. Bureau of Mines and A. W. Schlechten of the Missouri School of Mines published their work concerning “Reaction of Carbon and Metal Oxides in a Vacuum”. In this study, it was found that no refractory oxide was stable in contact with carbon in a vacuum at temperatures above 1380° C. Most of the reactions studied did not go to completion and in many cases; a mixture of oxide, metal, oxycarbides and carbides was formed.

Magnetic refrigeration is being considered as an alternative technique to gas compressor technology for cooling and heating based on engineering, economic and environmental considerations that indicate that active magnetic regenerator refrigerators, in principle, are more efficient than gas cycle refrigerators (e.g., 20% to 30%) and thus can yield savings in the cost of operation and conservation of energy. In addition magnetic cooling eliminates hazardous chemicals (e.g. ammonia gas, NH₃) ozone depleting gases (e.g. freon) and greenhouses gases, such as hydrofluorocarbons, that are used in conventional gas compression cooling.

Magnetic refrigeration utilizes the ability of a magnetic field to affect the magnetic part of a solid material's entropy to reduce it and increase the temperature of the solid material. When the magnetic field is removed, the change or return of entropy of the magnetic solid material reduces the temperature of the material. Thus, magnetic refrigeration is effected by cyclic heat dissipation and heat absorption in the course of adiabatic magnetization and adiabatic demagnetization of the magnetic solid material via application/discontinuance of external magnetic fields. A refrigeration apparatus that exhausts or vents the released heat on one side of the apparatus when the magnetic solid material is magnetized and cools a useful load on another side when the magnetic solid material is demagnetized is known in the magnetic refrigeration art as an active magnetic regenerator magnetic refrigerator (also known by the acronym AMR/MR).

An example of a technique and application for creating magnetic refrigerant alloy materials is disclosed in U.S. Pat. No. 5,743,095, entitled “Active Magnetic Refrigerants Based on Gd—Si—Ge Material and Refrigeration Apparatus and Processes,” which issued to Gschneidner, Jr. et al. on Apr. 28, 1998 and is incorporated herein by reference in its entirety.

Another example of a magnetic refrigerant application is disclosed in U.S. Pat. No. 6,589,366, entitled “Method of Making Active Magnetic Refrigerant, Colossal Magnetorestriction and Giant Magnetoresistive Materials Based on Gd—Si—Ge Alloys,” which issued to Gschneidner, Jr. et al. on Jul. 8, 2003 and is incorporated herein by reference in its entirety.

An example of a method for providing magnetic refrigerant alloy materials is disclosed in U.S. Patent Application Publication No. US2003/0221750A1, entitled “Method of Making Active Magnetic Refrigerant Materials Based on Gd—Si—Ge Alloys,” by Pecharsky et al and published on Dec. 4, 2003.

The Gd₅(SiₓGe₁₋ₓ)₄ alloys have been proposed as a magnetic refrigerant alloy product because of their excellent magnetocaloric properties over a wide temperature range from ˜20 K to ˜350K. Other rare earth (R) intermetallic compounds with X (where X=Si, Ge, Ga, In, Sn and Pb) and having the 5R to 4X ratio (R₅X₄) have also been suggested as magnetic refrigerants. In addition to magnetic refrigeration, the R₅X₄-based materials are applicable as working bodies for magnetorestrictive transducers that presently use a variety of materials, such as nickel or Terfenol-D, and/or magnetoresistance read heads that use artificial multi-layers or lanthanum manganites (La₁₋ₓMₓMnO₃, where M=Ca, Ba, or Sr). The R₅X₄-based materials, where R is a rare earth metal and X are metals of Groups 13 and 14 (old Periodic Table Group numbers IIIA and IVA) or mixtures thereof, are of great interest in these applications. The X metals include gallium, indium, silicon, germanium, tin and lead.

The current method of making these R₅X₄-based materials is by co-melting the pure elements by arc melting or vacuum induction melting. The starting material for preparing these pure elements is usually their respective oxides, and subsequent processing to the pure metal is quite expensive since considerable chemical and metallurgical processing is required to obtain the alloying metallic elements in a reasonably pure form.

### SUMMARY OF THE INVENTION

The present invention provides a carbothermic reduction method for making an R₅X₄ alloy material where R is one or more rare earth elements and X is one or more of non-rare earth alloying elements by carbothermically reducing amounts of a rare earth element-containing oxide, a reactant selected from one or both of an alloying element-containing oxide and the alloying element in elemental or alloy form, and carbon at elevated temperature to form an R₅X₄ alloy material. R is selected from the group consisting of La, Ce, Sm, Eu, Gd, Tb, Dy, Ho, Er, Tm, Lu, Sc, and Y. The alloying element X can be selected from the group consisting of a Group IIIA metal, a Group IVA metal or a combination thereof, such as including but not limited to, silicon, germanium, tin, lead, gallium, indium and mixtures thereof.

An illustrative embodiment of the present invention involves heating amounts of a rare earth element R-containing oxide, non-rare earth alloying element-containing oxide and carbon to at least 1500° C. under subambient pressure to obtain an R₅X₄ material. The R₅X₄ material then is melted and solidified in a manner to provide a reduced alloy carbon content so that the material as solidified from a molten state and optionally heat treated exhibits a magnetocaloric effect for an intended magnetic refrigeration and other applications. In lieu of the non-rare earth alloying element-containing oxide, the alloying element in elemental or alloy form can be used as a reactant in the carbothermic reduction.

In illustrative embodiments of the invention, the carbothermic reduction is effected by heating the oxide, reactant and carbon in at least two steps, each step lasting at least 5 minutes. Preferably at temperatures above 1500° C. each step lasts between 30 and 100 minutes. The alloy material is then melted, solidified and optionally heat treated to produce a high purity R₅X₄ intermetallic compound. Preferably only one by-product gas is evidenced following the reduction reaction thereof. Practice of such a method results in an overall yield in producing the R₅X₄ material that is greater than 98%.

The present invention envisions providing a high purity R₅X₄ alloy that exhibits, after solidification from a molten state and optionally heat treated, a large magnetocaloric effect (MCE), a large magnetoresistance and a large magnetostriction values. In addition to magnetic refrigerant alloys, the invention envisions providing R₅X₄ alloy that can be utilized as a part of any device (e.g. a sensor) where a part of the device or all of the device are subject to a change in shape, temperature, magnetization, electrical or thermal conductivity and/or where any other physical property is required and can be triggered by varying either or all of the external thermodynamic variables: magnetic field, temperature, and pressure. To this end, the invention envisions a solidified R₅X₄ magnetic refrigerant alloy product that exhibits a large magnetocaloric effect (MCE), a magnetoresistive alloy product, and a large magnetorestrictive alloy product for a magnetoresticitve transducer for example.

In another particular illustrative embodiment of the present invention, the oxide reactant materials may constitute, for example, Gd₂O₃, SiO₂ and GeO₂ and carbon to produce R₅X₄ magnetic refrigerant alloy material having a Gd₅Si₂Ge₂ composition, or other alloys compositions in the pseudo binary Gd₅(Si₁₋ₓGeₓ)₄ system where 0≦x≦1.

An alternate procedure to prepare the R₅X₄ materials is to substitute elemental Si and/or Ge for their respective oxides (SiO₂ and/or GeO₂). A low grade of Si and/or Ge rather than a high purity semiconductor grade material can be used as a starting material. One advantage is that less carbon is required to form the R₅X₄ material. A second advantage is that less CO is generated.

Advantages and features of the present invention will become more readily apparent from the following detailed description taken with the following drawings.

### BRIEF DESCRIPTION OF THE DRAWINGS

FIG. 1 illustrates a graph depicting a trace of the by-product gases produced during the preparation of Gd₅(Si₂Ge₂), in accordance with an embodiment of the invention.

FIG. 2 illustrates a graph depicting a comparison between the MCE of Gd₅(Si₂Ge₂) alloys prepared by metallothermic processing and by the carbothermic processing technique with respect to Example I herein, in accordance with an embodiment invention.

FIG. 3 illustrates a screen shot (photomicrograph) of a Gd₅Si₂Ge₂ sponge mix heated to 1530° C., wherein the dark areas indicate Gd-rich oxides at 250× resolution, in accordance with an embodiment invention.

FIG. 4 illustrates a screen shot (photomicrograph) of Gd₅Si₂Ge₂ as reduced, solidified, and heat treated at 1600° C. at 250× resolution, in accordance with an embodiment invention.

FIG. 5 illustrates a flow chart of operations depicting operational steps that may be followed for carbothermic processing, in accordance with an embodiment of the invention. The same flow chart applies when the XO₂ is substituted by the alloying element in elemental or alloy form.

### DETAILED DESCRIPTION OF THE INVENTION

The present invention provides an economical carbothermic reduction method for making an R₅X₄ alloy material where R can be selected from the group consisting of La, Ce, Sm, Eu, Gd, Tb, Dy, Ho, Er, Tm, Lu, Sc, and Y. One or more optional rare earth elements that may be included as alloying element(s) in the material in addition to R can be one or more of Nd and Pr. The alloying element X can be selected from the group consisting of a Group IIIA metal, a Group IVA metal or a mixture thereof. The alloying element X is preferably selected from the group consisting of silicon, germanium, tin, lead, gallium, indium and combinations thereof.

The carbothermic reduction process is a solid state, diffusion controlled process and intimate contact between the carbon reducing agent and the oxide and reactant particles is employed for the reduction to reach completion. The optimum particle size of the rare earth-containing oxide, reactant particles, and carbon, and the best conditions for milling and blending the mixture thereof can be selected to this end. The Examples below illustrate certain exemplary parameters for carrying out the carbothermic reduction reaction for purposes of illustration and not limitation.

For purposes of illustration and not limitation, the rare earth element-containing oxide can comprise suitable oxide particulates such as, R₂O₃ where R is defined above. The non-rare earth alloying element likewise can comprise suitable oxide particulates such as, XO₂ and X₂O₃ where X is defined above, for purposes of illustration and not limitation. Such oxides are available as commercial grade, high purity oxide particles (purity of 99.9%) in a particle size range of 40 to 200 μm as described in the Examples below. The non-rare earth alloying element alternatively can comprise suitable particulates of the non-rare earth alloying element in elemental form or alloy form for purposes of illustration and not limitation. Such elemental or alloy particles (e.g. Si or Ge) are available as commercial grade, low purity particles (purity of 98 to 99.9%) in a particle size range of 200 to 10 μm.

The carbon used as the reducing agent in the carbothermic reduction reaction can be of any suitable type, such as including but not limited to, Shawinigan (acetylene black) type available from Chevron Chemical Co. that is 100% compressed, 325 mesh, and contains less than 0.05% ash and can be used as-received. The Examples described below used such carbon in the “as-received” condition. Other types of carbon that can be used include, but are not limited to acetylene black type.

In one embodiment of the invention, a particulate mixture of the rare earth element-containing oxide, non-rare earth alloying element-containing oxide and carbon reducing agent is prepared by milling the particles and blending them together. In another embodiment of the invention, a particulate mixture of the rare earth element-containing oxide, non-rare earth alloying element in elemental form or alloy form, and carbon reducing agent is prepared by milling the particles and blending them together. The mixture is then formed into a paste by adding a binder in a solvent carrier to the mixture. The paste then can be formed into cubes (or other shaped bodies) and air dried to form briquettes, which have good strength and are easily loaded into the tantalum, Al₂O₃ or other reduction crucible. The dried briquettes can be heated in a tungsten resistance or other type of furnace under vacuum to an appropriate temperature at or above the onset temperature of the carbothermic reduction reaction and for a time to complete the reduction reaction to form the R₅X₄ alloy material. The reaction can be-monitored using a quadrupole gas analyzer to monitor by-product gases such as CO as described below The particulate mixture preferably is heated to the liquid or molten state after the carbothermic reduction reaction is completed to allow the oxygen and carbon time to react and form CO, thereby reducing the oxygen and carbon content of the alloy material to a relatively low content such as about 1.5 weight % of O and C or less for purposes of illustration and not limitation so that the alloy material exhibits a large magnetocaloric effect, a large magnetoresistance value, and a large magnetostriction value as an alloy product for use as a magnetic refrigerant, magnetoresistive part, and magnetorestrictive part.

The carbothermic reduction method preferably involves heating briquette material containing appropriate amounts of the oxide reactant materials and carbon to at least 1500° C., more preferably at about 1550° C., under a vacuum to obtain the R₅X₄ alloy material. Preferably, the heating of the oxide reactants and the carbon occurs in at least two steps, each step lasting at least 5 minutes. Preferably at temperatures above 1500° C. each step lasts between 30 and 100 minutes. The molten R₅X₄ alloy material is then solidified and optionally heat treated to produce an R₅X₄ alloy material. Melting, solidification, and heat treatment can be conducted in the same container, such as a crucible, in which the carbothermic reduction is carried out. Preferably only one by-product gas such as CO is evidenced following the reduction reaction thereof. Such a method results in an overall yield in producing the R₅X₄ alloy material that is greater than 98%.

For purposes of illustration and not limitation, the carbothermic reduction reaction can be represented as indicated by equations (1) through (4), see below:

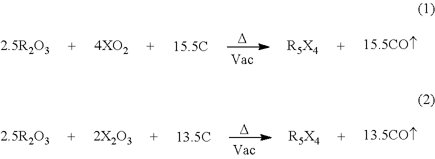

In equations (1) and (2) above, R₂O₃ represents the rare earth element-containing oxide, while XO₂ [in Eq. (1)] and X₂O₃ [in Eq. (2)] represent the alloying element-containing oxide of the alloy element for example where X=Si, Ge, Sn, and Pb (Eq. 1) and X=Ga and In (Eq. 2) and R₅X₄ represents the intermetallic alloy formed. The carbon monoxide (CO) effluent may be removed by a vacuum pumping system and then vented; or utilized as a starting material for preparing organic compounds, or as a component of producer gas (also known as water gas) for cogeneration of heat or electricity.

In the case where elemental Si is used instead of SiO₂ along with GeO₂ for the preparation of Gd₅Si₂Ge₂ the chemical reaction is:

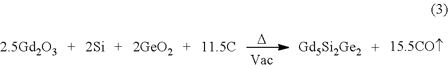

For the case where both elemental Si and Ge are used instead of the respective oxide the chemical reaction is:

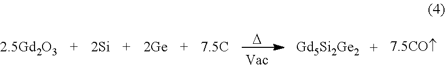

The carbothermic reduction method is advantageous in that pure intermetallic alloys can be prepared not only because the oxygen is removed from the system as gaseous carbon monoxide but the compounds of interest have high negative heats of formation (ΔH) which assists in driving the reduction reaction to completion without the formation of stable carbides. The method includes drying the reactant oxide or alloying element, screening to a small particle size, weighing, and blending with the carbon reductant and forming a briquette. Such briquettes can be then heated to an elevated temperature under subambient pressure (vacuum) to complete the reduction, thereby forming the alloy, which is then melted, solidified and heat treated (if necessary).

The carbothermic reduction method of the invention is further advantageous in that it is capable of producing high purity R₅X₄ alloys and is much less expensive than present methods because one begins with oxides of the materials which are usually available in their most inexpensive form. Carbon is also inexpensive and can be used as the reducing agent rather than calcium or magnesium, which are used to prepare the pure rare earth metal and are much more expensive than carbon. The cost associated with practice of the method of the invention can be at least 50% less than present methodology involving the direct reaction of stoichiometric amounts of Gd, Si, and Ge.

Moreover, the carbothermic reduction method of the invention can provide for an efficiency of greater than 98% and is also environmentally friendly since no slag is formed during preparation, and the only by-product is carbon monoxide gas, which can be absorbed or ignited to carbon dioxide; or utilized as a starting material for preparing organic compounds, or as a component of producer gas (also known as water gas) for cogeneration of heat or electricity. For purposes of illustration in producing a Gd₅(SiₓGe₁₋ₓ)₄ alloy where x is 0≦x≦1, the efficiency can be defined as the sum of the Gd₅(SiₓGe₁₋ₓ)₄ alloy produced and the silicon and germanium contents of the sublimed SiO and GeO formed from the corresponding Gd₂O₃, SiO₂ and GeO₂ starting reactants mixture. The sublimed SiO and GeO can be collected and reused in a subsequent run. A major advantage of the method of the invention involves use of the carbothermic reduction to the metal state and solidification and the optional heat treatment of the alloy, which can all be accomplished in a single processing step or cycle. The alloy materials prepared by this process are high purity and exhibit larger magnetocaloric effects than those of materials prepared using commercial grade metals, unless special processing techniques are employed.

In addition, the method of the invention can be used to produce near kilogram quantities of R₅X₄ alloy material, such as Gd₅Si₂Ge₂, in a single heating step in the same container (e.g. crucible). Such a method can be successfully employed in creating R₅X₄ alloy materials to exact specified compositions and possible near-net shapes for use in parts or bodies for magnetic refrigeration applications, magnetoresistance applications, magnetostriction applications.

### Exemplary Carbothermic Method

The following description sets forth exemplary parameters for a practicing the carbothermic reduction method for purposes of illustration and not limitation.

### Preparation of Reactant for Reduction

The respective rare earth oxide and the oxide of the alloying element(s) are first dried separately at 800° C. in air to remove any adhering moisture, non-oxidized material and/or absorbed gases. The oxides are then screened to a particle diameter of <212 μm.

The carbon utilized as the reducing agent may be of, for example, commercial grade Shawinigan Acetylene Black, 100% compressed with a carbon content of >99.95% and a particle diameter of <45 μm. Such a material can be used in the “as-received” condition.

For a specific intermetallic alloy preparation, the respective oxides of the rare earth element (R) and of the alloying agent (X) can be weighed with the “as-received” carbon in the proper near-stoichiometric amounts, based on the reduction of the oxide to metal with the evolution of CO. The oxide-carbon mixtures can be then blended for two (2) hours and readied for reduction by forming into briquettes, nearly cubic in shape. This can be accomplished by first adding acetone containing, for example, 3 wt. % polypropylene carbonate (QPAC) to the oxide-carbon mixture until a pliable mass is formed and then shaping the mass into briquettes by manually forming or by extrusion. The acetone can be removed by, for example, air drying overnight or by heating at 100° C. in vacuum.

The above-described preparation applies similarly when the non-rare earth alloying element—containing oxide reactant is substituted by particles of the alloying element in elemental form or alloy form, except they are not dried.

### Carbothermic Reduction to Form Intermetallic Alloys

The briquettes containing the oxide/reactant-carbon mixtures can be placed into a tantalum metal crucible and loaded into either a low pressure resistance furnace or a low pressure induction furnace, both of which are capable of attaining 1900° C. while maintaining pressures of, for example, 5×10⁻⁵ Torr at temperature. The heating schedule for the reduction step is preferably computer controlled and can be accomplished in a stepwise manner, depending upon at what temperature the reduction reactions take place.

A maximum holding temperature can be determined for each alloy, which corresponds to the maximum temperature that the briquettes were converted into a metallic sponge containing approximately 1.5% of each carbon and oxygen with no sign of melting. This temperature may be maintained until pressure attains, for example, 20-40 μm Hg at which time the pressure in the system is lowered and the temperature increases until the alloy melts. The alloy may be held molten until the carbon-dioxide reaction is completed after which time the system can be cooled to a lower heat treating temperature, if desired.

A thorough understanding of the composition of the by-product gases is used in carbothermic processing so that the exact amount of carbon is utilized as the reducing agent. The composition of these gases also assists in determining (1) the rate of heating, time at specific temperature; (2) when the reduction is complete; and (3) whether any gases are present that may compete with the reaction toward completion. Note that in the context of these experiments, a Stanford Research Systems CIS100 residual gas analyzer was used to assist in establishing the optimal processing conditions. It should be noted that only one by-product gas is ideal in the carbothermic processing in order to control the composition of the alloy products.

### Completing the Carbon-Oxygen Reaction

In many of the R₅X₄-based materials, excess carbon and/or oxygen can greatly affect the intrinsic properties of the materials prepared. This is especially true with the magnetocaloric alloy Gd₅(SiₓGe₁₋ₓ)₄. Several procedures were used to decrease one or both of these elements in the alloys prepared. These included utilizing a deficiency of the stoichiometric amount of carbon as the reductant, the use of the residual gas analyzer to trace the emission of the by-product gases during the reduction, and the use of tantalum strips to provide a “gettering” surface for carbon by forming the stable TaC or Ta₂C compounds.

### Deficiency of the Stoichiometric Amount of Carbon as the Reactant

Several carbothermic reductions of the Gd₂O₃, SiO₂, and GeO₂ mixture were made using a 2.5% to 4.0% deficiency of the amount of carbon reductant. The alloys prepared were all heated above their melting temperature for approximately 1 hour to ensure that the carbon-oxygen reaction was complete. The residual carbon content of alloys prepared utilizing a 4% deficiency was found to be less than 100 ppm(w) [parts per million by weight], but the oxygen was as much as 7000 ppm(w). In those experiments in which a 2.5% to 3% deficiency of carbon was used, and the carbon-oxygen reaction completed above the melting point, the carbon content in the alloy was <200 ppm (w) and the oxygen content <1500 ppm (w). In order to obtain these levels of carbon and oxygen, the processing preferably should be performed in a system that contains a minimum of carbon and/or oxygen bearing residual gases such as H₂O, CO and CO₂. Also, it was found in the course of such experiments that for the Gd₅Si₂Ge₂ alloy, a final processing at 1850° C. to 1860° C. may be necessary.

### Use of the Residual Gas Analyzer

A residual gas analyzer was used during several of the carbothermic reductions to trace the by-product gases thereby greatly assisting in establishing process temperatures and to ensure that the carbon-oxygen reaction was complete or in equilibrium with the residual gases in the system. These gases were traced from room temperature to the melting point of the alloy and during its solidification. For example, during the carbothermic processing to prepare Gd₅Ge₄ a small amount of H₂ and CO was emitted at temperature below 300° C. due to the decomposition of the polypropylene carbonate binder. No CO₂ was emitted until the temperature reached 925 to 950° C., which correspond to the melting point of germanium (935° C.) and the onset of the carbon reduction of GeO₂. At this reaction temperature both CO (˜90%) and CO₂ (˜10%) were emitted until the temperature increased to 1100° C. Above this temperature only CO was emitted, which gradually decreased to being non-detectable at 1810° C.

In experiments tracing the emission of by-product gases during the preparation of Gd₅Si₂Ge₂ from a mixture of Gd₂O₃, SiO₂, and GeO₂ a similar profile was obtained of the by-product gases as that observed in the preparation of Gd₅Ge₄. From 1300 to 1550° C., however, a larger amount of CO was emitted, which corresponds to the onset of the reduction of the Gd₂O₃ and SiO₂. This temperature range corresponds to the melting points of gadolinium (1312° C.) and silicon (1410° C.). Further, a small amount of CO was emitted between 1790 and 1860° C. due to formation of liquid Gd—Si—Ge via a peritectic reaction. The peritectic reaction for the formation of the Gd₅Si₂Ge₂ alloy occurs at 1790-1800° C. where liquid and solid alloy are present. The alloy is completely molten at 1825-1835° C. After maintaining the alloy molten in vacuum for one hour at 1860° C., very little of any CO was observed.

Lowering the Carbon Content by “Gettering” with Tantalum Strips

A portion of Gd₅Si₂Ge₂ alloy prepared by the carbothermic process and containing 5000 ppm(w) of carbon and 1500 ppm(w) of oxygen was recast at 1860° C. for 12 minutes. Several strips of tantalum metal which had been surface cleaned with 15% HF—HNO₃ acid were placed in the tantalum crucible along with the Gd₅Si₂Ge₂ alloy. After solidification, the alloy contained 960 ppm(w) carbon and 760 ppm(w) oxygen. This decrease in the carbon content cannot be solely attributed to the completion of the carbon-oxygen reaction at the 1860° C. temperature and in part is due to the carbon reacting with the clean tantalum crucible and the tantalum metal strips to form the stable compounds TaC or Ta₂C.

### Preparation of Various Gd₅(SiₓGe₁₋ₓ) Alloys

The particular values and configurations discussed in the following non-limiting examples can be varied and are cited merely to illustrate at least one embodiment and are not intended to limit the scope thereof.

### Example I

The magentocaloric alloy Gd₅Si₂Ge₂ was prepared by drying the Gd₂O₃, SiO₂ and GeO₂ at 800° C. for 24 hours and screening to a diameter <212 μm. A carbothermic reduction charge was prepared by intimately mixing 100.000 g of Gd₂O₃, 16.546 g of SiO₂, 26.675 g of GeO₂ and 22.117 g of carbon. This amount of carbon corresponds to 97.5% of the stoichiometric amount and was used to insure that almost all of the carbon was converted to CO during the reduction step. Approximately 140 cc of acetone was added to the mixture which was stirred to form a pliable mass which was formed manually into cube shaped briquettes measuring 1 to 1½ cm on a side. The briquettes were dried in air for 2 hours at 100° C. A 66.4 gram portion (36 briquettes) were placed into a 4.8 cm diameter×7 cm high tantalum metal crucible equipped with a tantalum thermocouple well and a lid containing four holes measuring 0.6 cm in diameter.

The crucible was then loaded into a vacuum furnace equipped with a tungsten resistance heater. A Type C thermocouple (W-5% Re vs. W-26% Re) was inserted into the thermocouple well and the system evacuated. After the system was out gassed for approximately 1 hour at a pressure of 5×10⁻⁵ Torr, the diffusion pump was isolated from the system with only the mechanical vacuum pump opened to the system. The charge was then heated to 1100° C. at a rate of 20° C./min. and held for 6 min. It was then heated to 1400° C. at a rate of 10° C./min. and held for 6 min. The temperature was then increased at a rate of 10° C./min to 1540° C. and held at this temperature until the pressure reached 10 μm which took approximately 50 min. The pressure in the system was then lowered using the diffusion pump and the now metallic briquettes heated at 10° C./min. to 1860° C. and held for 6 min. at which temperature the Gd₅Si₂Ge₂ magnetocaloric alloy is molten. The alloy was cooled to 1800° C. and held for 1 hour after which it was cooled, solidified and heat treated at 1600° C. to insure uniform composition. The alloy was then cooled at 50° C./min. to 1000° C. after which the electrical power to the furnace was shut off and the alloy quickly cooled.

The prepared alloy was bright, shiny, and weighed 41.0 g which corresponded to a 91% yield and contained 145 ppm (wt.) carbon, 1425 ppm (wt.) oxygen and 15 ppm (wt.)nitrogen. The low yield (i.e. <100%) is due to the loss of GeO and SiO during the soaking period when the alloy was in the molten state to reduce the carbon and oxygen contents by the formation of CO which is pumped off by the vacuum pumps. The Gd₅Si₂Ge₂ product had the monoclinic crystal structure, which exhibits the giant magnetocaloric effect, as determined by x-ray analysis. The magnetocaloric effect (MCE) properties of the prepared alloy were also determined. The value for −ΔSₘ(J/kgK), the change of the magnetic entropy, and the magnetic ordering (Curie) temperature (T_{c}) were determined to be 18.8 (J/kgK) at 276.6° K. These values compare favorably with those obtained from the Gd₅Si₂Ge₂ magnetocaloric alloy prepared from commercial grade elements.

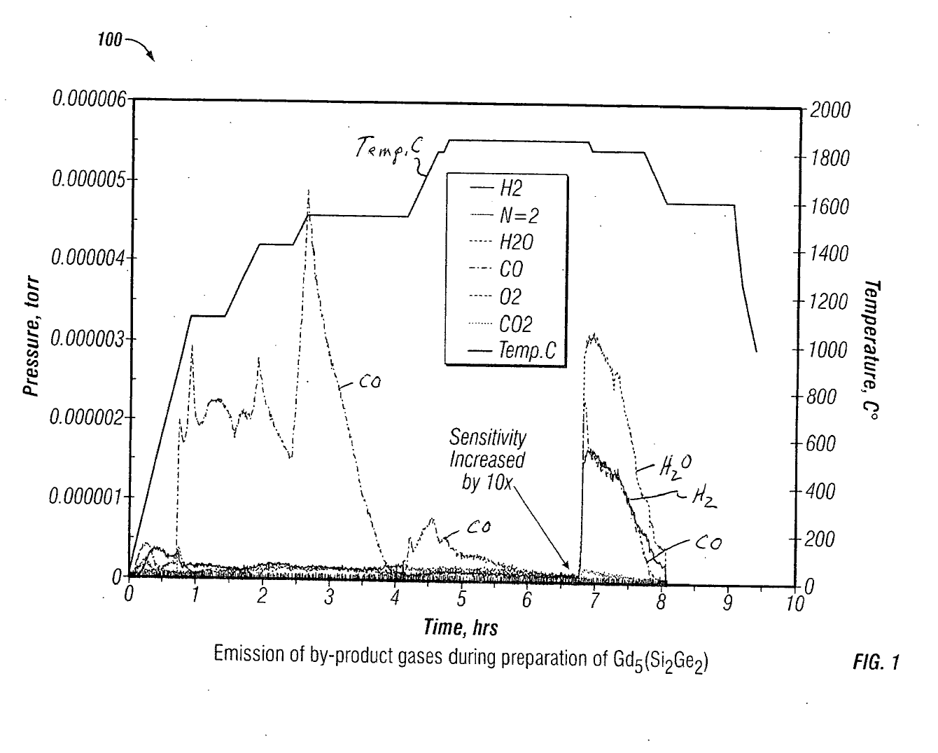

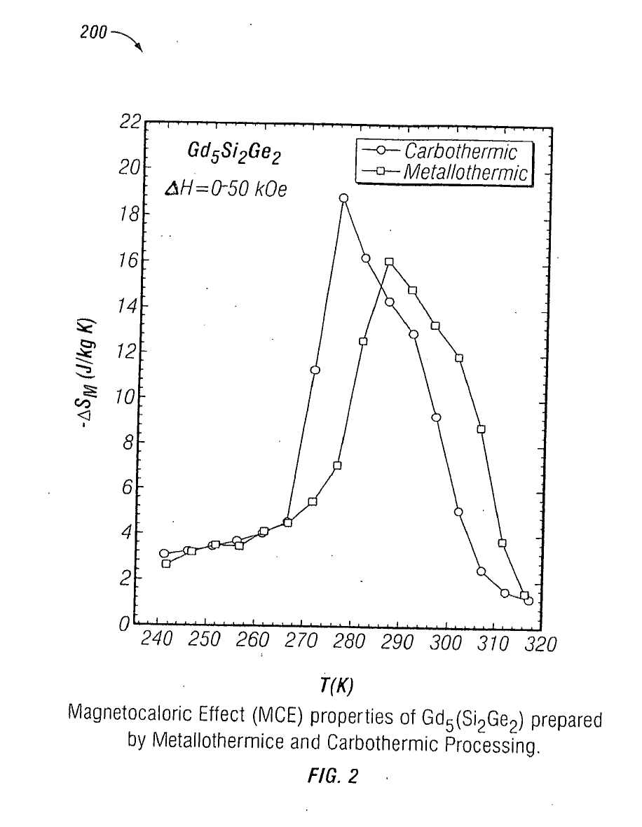

Note that FIG. 1 illustrates a graph 100 depicting a trace of the by-product gases produced during the preparation of Gd₅(Si₂Ge₂), in accordance with an embodiment. FIG. 2 illustrates graph 200 depicting a comparison between Gd₅(Si₂Ge₂) alloy prepared by metallothermic processing and by the carbothermic processing technique with respect to Example I herein, in accordance with an embodiment;

### Example II

A Gd₅Si₄ intermetallic alloy was prepared from a carbothermic reduction mixture that contained 50.000 g of Gd₂O₃, 14.916 g of SiO₂ and 10.934 g of carbon (100% of stoichiometric amounts). A 10% excess of silicon as SiO₂ was used to compensate for the volatility of SiO. The dried and screened (<212 μm particle diameter) oxides were first thoroughly blended with the carbon and then ˜65 cc of acetone containing 3 wt. % polypropylene carbonate were added and stirred into a pliable mass. Cube shaped briquettes measuring 1 to 1½ cm on a side were formed manually on a Teflon sheet. The 3 wt. % polypropylene carbonate served as a non-contaminating binder and increased the strength of the dried briquettes ten-fold, which greatly facilitated handling and loading of the briquettes into the reduction crucible. A 35.6 gram portion of the dried briquettes were placed into the 4.8 cm diameter×7 cm high tantalum crucible, the lid and thermocouple attached and the assembly loaded into the resistant heated vacuum furnace.

The system was out gassed as in Example I, and utilizing only the mechanical vacuum pump, the tantalum crucible and reduction charge was heated in a stepwise manner. The charge was heated at 10° C./min. to 1100° C. and held for 6 min., heated at 20° C./min. to 1400° C. and held for 6 min., and then heated to 1600° C. at 10° C./min. and held at this temperature until most of the reduction had taken place as indicated by the pressure decreasing from 900 μm to 12 μm which took 30 min. The diffusion pump was then used to decrease the pressure and the metallic sponge heated at 10° C./min. to 1780° C. and held for 1 hour. The pressure at temperature was 5×10⁻⁵ Torr and slowly decreased as the evolution of CO subsided and the carbothermic reaction was completed. The alloy was then cooled to 1600° C. held for 1 hour to insure that the peritectic reaction was complete and then quickly cooled to room temperature.

The prepared alloy contained >90% Gd₅Si₄ and <10% GdSi (due to the excess Si added to starting charge) by x-ray analysis. It contained 235 ppm (wt.) carbon, 6000 ppm (wt.) oxygen and 20 ppm (wt.) nitrogen with an overall yield of 92%. The remaining 8% is due to the loss of SiO by sublimation during the long holding times at 1780° C.

### Example III

The carbothermic process was scaled so that 500 to 650 g of the R₅X₄ alloy was prepared. This preparation was done in a Vacuum Industries Corporation vacuum induction furnace that has a coil assembly that can be tilted. This unit is capable of processing 3000 g of 2.5 cm cube briquettes contained in a tantalum crucible. The unit was equipped with a Eurotherm controller which enabled temperature control within 2° C. at 1850° C. Two Type C thermocouples (W-5% Re vs. W-26% Re) were inserted between the tantalum susceptor and the tantalum reduction crucible. In this particular example, 511 g of Gd₅Si_{4.06} were prepared from a stoichiometric mixture of Gd₂O₃, SiO₂ and carbon according to equation (5) below:

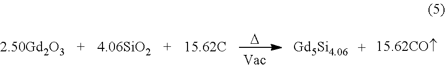

The reduction charge included 522.505 g of Gd₂O₃, 140.908 g of SiO₂ and 108.273 g of carbon which was the stoichiometric amount. The dried oxides were processed through a 212 μm screen and blended with the carbon utilizing a blender, such as, for example, a Turbula® Powder Blender. Note that a “Turbula” blender is one example of a blending apparatus utilized to extracting powder blending and mixing applications. Examples of such applications include, for example, but are not limited to, blending extremely heavy powders with very light ones, mixing very small quantities of powders into larger volumes, gently blending fragile granules without crumbling, successfully mixing particles of different diameters, and so forth. The blended oxides and carbon were mixed with acetone containing 3 wt. % polypropylene carbonate so that a pliable mass was obtained from which cube shaped briquettes measuring ˜1.6 cm on a side were formed. The acetone was removed by drying overnight at room temperature.

In this particular experiment, one hundred of these briquettes were loaded into the 10 cm diameter by 25 cm high tantalum reduction crucible which was placed inside the tantalum metal susceptor. Appropriate insulation was added, and the system evacuated utilizing both mechanical and diffusion pumps to achieve a pressure of 8.6×10⁻⁶ Torr. The diffusion pump was then isolated leaving only the mechanical pump opened to the system. The charge was heated to 1100° C. at a rate of 10° C./min. and held for 30 min. The temperature was then increased to 1400° C. at a rate of 20° C./min. and held for 30 min.

After this time the temperature was raised to 1600° C. and maintained until the pressure decreased from 250 μm to 30 μm which took ˜100 min. The pressure was then lowered by valving the diffusion pump into the system after which the temperature was increased to 1790° C. at a rate of 10° C./min. After holding at this temperature for 60 min., the coil and crucible assembly was tilted to a 30° angle from horizontal so that the liquid alloy covered slightly less than one-half the bottom of the crucible. After tilting, the alloy was cooled to 1700° C. and held for 1 hour for homogenization and heat treatment. The power to the system was then terminated and the reduction product cooled to room temperature.

From x-ray analyses, this alloy contained 70% Gd₅Si₄ and 30% GdSi. The high concentration of GdSi in the alloy was undoubtedly due to less than a 100% reduction of the Gd₂O₃ thereby making the alloy rich in silicon. The carbon content was 0.8 wt. % which was expected since 100% of the stoichiometric amount of carbon was used as the reductant. The carbon content would be decreased if a slight deficiency of carbon was used. A 98.3% metal yield was obtained.

### Example IV

A 580 gram alloy of Gd₅Si₂Ge₂ was prepared by the carbothermic reduction process using a high capacity vacuum induction furnace according to equation (6) below:

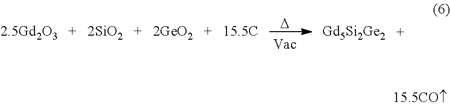

The reduction mixture in this particular example contained 529.357 g of Gd₂O₃, 75.820 g of SiO₂, 170.844 g of GeO₂ and 117.283 g of carbon. These amounts included 9 wt. % excess SiO₂, and 29 wt. % excess GeO₂ in order to allow for the volatilization of the sub oxides SiO and GeO during heating. A 4 wt. % deficiency of carbon was used to minimize the carbon concentration in the Gd₅Si₂Ge₂ alloy. The oxides were dried at 800° C. for 20 hours in air and processed through a 212 μm screen. The mixtures were then blended for 2 hours using a Turbula blender after which time briquettes were prepared. A pliable mass of the dry oxide blend was obtained by mixing 673 g that contained 25 g of polypropylene carbonate.

Cubic shaped briquettes measuring ˜2.5 cm on a side were hand formed. They were then air dried at room temperature overnight prior to loading into the 10 cm diameter tantalum reduction crucible. The loaded crucible was placed inside the tantalum susceptor, which was wrapped with zirconium oxide (e.g., Zircar) sheet insulation. The assembly was placed inside the induction coil and the furnace evacuated to 6.6×10⁻⁶ Torr using both mechanical and diffusion pumping. The diffusion pump was then valved out of the system and heating initiated using only the mechanical pump. The Eurotherm controller regulated the rate of heating, the temperature (within ±2° C.), and time at the various temperatures. The charge was heated to 1100° C. at 20° C./min. and held for 30 min. The temperature was then increased to 1400° C. at a rate of 20° C./min and held for 30 min.

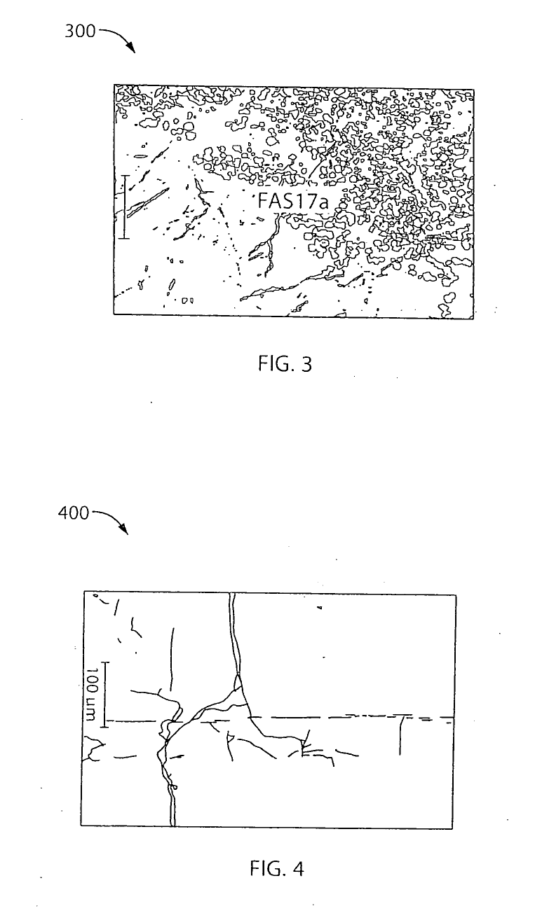

After this time the temperature was raised to 1530° C. for 140 min. after which time the pressure inside the vacuum chamber was 40 μm. Note that FIG. 3 illustrates a screen shot 300 (photograph) of a Gd₅Si₂Ge₂ sponge mix heated to 1530° C., wherein the dark areas indicate Gd rich oxides, in accordance with an embodiment. In the screen shot illustrated in FIG. 3, a mix of 5:3, 5:4, and some 1:1 compounds at 250× is depicted. FIG. 4 illustrates a screen shot 400 (photograph) of Gd₅Si₂Ge₂ as reduced, solidified, and heat treated at 1600° C. at 250× resolution, in accordance with an embodiment.

The diffusion pump was valved back into the system and the charge heated to 1800° C. at 10° C./min. and held for 5 min. The temperature was increased to 1850° C. and held for 60 min. During this hold the pressure slowly decreased to 2.4×10⁻⁴ Torr. The alloy was cooled to 1800° C. and the coil and crucible assembly tilted to 30° of horizontal, and the alloy further cooled to 1600° C. at 10° C./min. and held for 60 min. The power was then turned off and the alloy cooled to room temperature.

The weight of the resulting alloy corresponded to a 95.0% metal yield. A 39.2 g deposit of SiO and GeO were removed from the collector located directly above the reduction charge. The silicon and germanium contained in this deposit combined with the alloy weight totaled a 99.8% material recovery (i.e. the efficiency). The SiO and GeO collected were oxidized and could be used in another alloy preparation. From x-ray analysis, this alloy was of the Gd₅Si₂Ge₂ stoichiometry. About 60% of the alloy had the monoclinic structure and about 40% was of the orthorhombic structure. The percentage of the monoclinic and orthorhombic phases can be changed by the appropriate heat treatment as described earlier by the authors.

### Example V

The magnetocaloric alloy Gd₅Si₂Ge₂ was also prepared by drying the Gd₂O₃ and GeO₂ at 800° C. for 24 hours and screening to a diameter of <212 μm and then adding elemental Si particles screened to a diameter of <125 μm as the source of Si instead of SiO₂, see Equation (3). A carbothermic reduction charge was prepared by intimately mixing 50.000 g of Gd₂O₃, 3.868 g of Si, 13.337 g of GeO₂ and 7.833 g of carbon. This amount of carbon corresponds to 97.5% of the stoichiometric amount and was used to insure that almost all of the carbon was converted to CO during the reduction step. The mixture was thoroughly blended and 43 cc of acetone containing 3 wt. % polypropylene carbonate were added and stirred into a pliable mass. Briquettes measuring 0.6 cm thick and approximately 1.2 cm by 1.2 cm were formed and air dried overnight at room temperature. A 32.391 g portion of these briquettes were placed in a 4.8 cm diameter×7 cm high tantalum metal crucible equipped with a tantalum thermocouple well and lid containing six holes measuring 0.6 cm in diameter.

The crucible was loaded into a vacuum furnace equipped with a tungsten resistance heater. A Type C thermocouple (W-5% Re vs. W-26% Re) was inserted into the thermocouple well and the system evacuated. After the system was evacuated overnight at a pressure of 1×10⁻⁶ Torr, the diffusion pump was isolated from the system with only the mechanical vacuum pump opened to the system. The charge was heated to 1100° C. at a rate of 20° C./min. and held for 6 minutes. It was then heated to 1400° C. at a rate of 20° C./min. and held for 6 minutes. The temperature was then increased at a rate of 10° C./min. to 1540° C. and held at this temperature until the pressure reached 15 μm which took approximately 45 minutes. The pressure in the system was then lowered using the diffusion pump and the metallic briquettes heated at 10° C./min. to 1860° C. and held for 6 minutes at which temperature the Gd₅Si₂Ge₂ magnetocaloric alloy is molten. The alloy was cooled to 1800° C. and held for 1 hour after which it was cooled, solidified and heat treated at 1600° C. to insure uniform composition. The alloy was then cooled at 50° C./min. to 1000° C. after which the electrical power to the furnace was shut off and the alloy quickly cooled.

The prepared alloy was bright, shiny and weighed 17.000 g which corresponded to a 92.5% yield and contained 125 ppm (wt.) carbon, 2220 ppm (wt.) oxygen and 35 ppm (wt.) nitrogen. The low yield (i.e. <100%) is due to the loss of GeO and SiO during the soaking period when the alloy was in the molten state to reduce the carbon and oxygen contents by the formation of CO which is pumped off by the vacuum pumps. The Gd₅Si₂Ge₂ product contained both the monoclinic phase (˜50%)) and orthorhombic phase (˜24%) plus some SiC and Si. The magnetocaloric effect was −11.5 J/kgK. The alloy was heat treated at 1300° C. for two hours, and the amount of the monoclinic phase increased to 63% while the orthorhombic phase content decreased to 17%. The magnetocaloric effect improved to −12 J/kgK. As noted above the relative percentages of the monoclinic and orthorhombic phases can be changed by the appropriate heat treatment to improve the magnetocaloric properties as described earlier by the inventors.

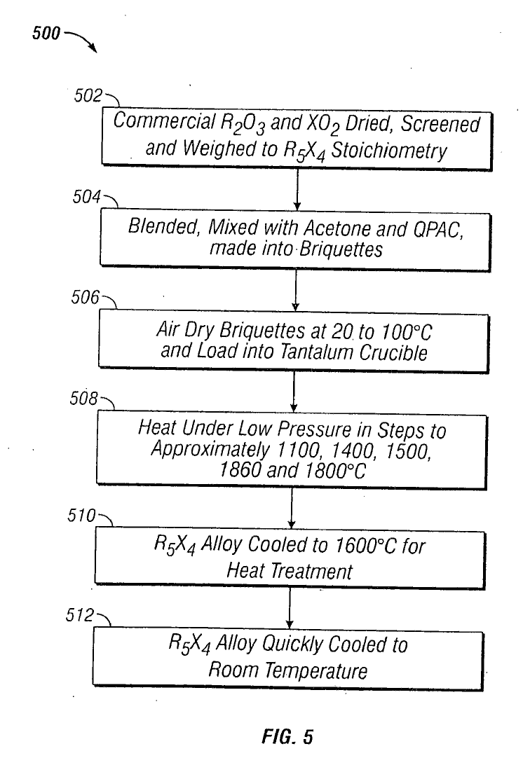

FIG. 5 illustrates a high level flow chart of operations depicting logical operational steps of a method 500 that may be followed for carbothermic processing, in accordance with an embodiment. Method 500 summarizes preferred steps for implementing the carbothermic processing technique disclosed herein. It can be appreciated, of course, that variations the method 500 may also be implemented, in accordance with alternative embodiments. As indicated at block 502, commercial R₂O₃ and XO₂ can be dried, screened and weighed to R₅X₄ stoichiometry. Next, as illustrated at block 504, the Compound can be blended, mixed with acetone and QPAC, and formed into briquettes as described in greater detail herein. Thereafter, as depicted at block 506, the briquettes can be air dried at 20 to 100° C. and loaded into a tantalum crucible. Then, as described at block 508, the compound can be heated under low pressure in steps to approximately 1100° C., 1400° C., 1500° C., 1860° C. and 1800° C. The R₅X₄ alloy can be then cooled to 1600° C. for heat treatment, as indicated at block 510. Finally, the R₅X₄ alloy can be cooled to room temperature, as illustrated at block 512.

Based on the foregoing, it can be appreciated that a number of advantages stem from the practice of the carbothermic method, including the use of low cost oxides as reactant materials, low cost high purity carbon as a reducing agent, and the fact that the reduction, casting and heat treatment (if necessary) can be accomplished in a single heating step. Further, no slag is formed by the reduction reaction and the carbon-monoxide by-product gas is environmentally friendly since it can be absorbed or ignited to carbon dioxide; or utilized as a starting material for preparing organic compounds; or utilized as a component of producer gas for cogeneration of heat or electricity. The overall yield of preparing R₅X₄ alloy materials by this carbothermic process is greater than 98%. Also, this process is capable of configuring near-net shape objects, such as perforated monolithic cylinders, and/or blocks of R₅X₄ materials containing micro channels. Note that the reactant materials discussed herein may comprise Gd₂O₃, SiO₂ and GeO₂ and the R₅X₄ material may constitute an alloy having a Gd₅Si₂Ge₂ composition. In other embodiments, the R₅X₄ material may be an alloy having a Gd₅(Si₁₋ₓGeₓ)₄ pseudo binary composition, depending of course upon design considerations.

Another advantage stems from the fact that the final R₅X₄ alloy products are high purity materials, which exhibit a large value of magnetocaloric effect (MCE) due to a limited amount of interstitials, especially carbon, which lower the value of MCE or even destroys the giant magnetocaloric effect. The large MCE increases the efficiency of regenerator materials.

The method of the invention for preparing R₅X₄ alloy materials by carbothermic processing can find use in a number of applications, such as, for example, magnetic refrigerators, freezers, magnetic air conditioners, magnetorestrictive transducers, and magnetoresistance read heads. Such an approach is also useful with any device requiring a large change in magnetization, shape, electrical resistance as functions of magnetic field, temperature and/or pressure.

It will also be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of preparing an R₅X₄ material, where R is a rare earth element selected from the group consisting of La, Ce, Sm, Eu, Gd, Tb, Dy, Ho, Er, Tm, Lu, Sc, and Y and X is an alloying element comprising a Group IIIA metal, a Group IVA metal or a combination thereof, comprising carbothermically reducing amounts of a rare earth element R-containing oxide, a reactant selected from one or both of an alloying element-containing oxide and the alloying element in elemental or alloy form, and carbon at elevated temperature to form an R₅X₄ material.

2. The method of claim 1 wherein X is selected from the group consisting of silicon, germanium, tin, lead, gallium, indium and combinations thereof.

3. The method of claim 1 including heating the amounts of the rare earth element-containing oxide, the alloying element-containing oxide, and carbon to a temperature of at least 1500° C. under subambient pressure to form the material.

4. The method of claim 3 further including heating the material to a molten state.

5. The method of claim 4 including solidifying the molten material.

6. The method of claim 5 including heat treating the solidified material.

7. The method of claim 6 wherein the alloy material is rendered molten, is solidified and is heat treated in the same container.

8. The method of claim 1 wherein only one by-product gas follows said carbothermic reduction reaction.

9. The method of claim 1 wherein said rare earth element-containing oxide comprises Gd₂O₃

10. The method of claim 9 wherein said reactant comprises the alloying element-containing oxide comprising SiO₂ and GeO₂.

11. The method of claim 9 wherein said reactant comprises elemental Si and Ge.

12. The method of claim 9 wherein said reactant comprises elemental Si and GeO₂.

13. The method of claim 9 wherein said reactant comprises elemental Ge and SiO₂.

14. The method of claim 9 wherein the carbon comprises acetylene black type carbon.

15. The method of claim 9 wherein said R₅X₄ material comprises an alloy having a Gd₅Si₂Ge₂ composition.

16. The method of claim 9 wherein said R₅X₄ material comprises an alloy represented by Gd₅(Si₁₋ₓGeₓ)₄ where x is 0≦x≦1.

17. The method of claim 1 wherein R optionally may include one or both of Nd and Pr as an alloying element in addition to R.

18. A magnetic refrigerant alloy product made by the method of claim 5.

19. A magnetostrictive alloy product made by the method of claim 5.

20. A magnetoresistive alloy product made by the method of claim 5.

21. A magnetic refrigerant alloy product made by the method of claim 6.

22. A magnetostrictive alloy product made by the method of claim 6.

23. A magnetoresistive alloy product made by the method of claim 6.
